(19) United States
(12) Patent Application Publication
(10) Pub. No.: US 2016/0048316 A1
(43) Pub. Date: Feb. 18, 2016

(54) ELECTRONIC DEVICE AND METHOD FOR PROVIDING USER INTERFACE

(71) Applicant: Samsung Electronics Co., Ltd., Gyeonggi-do (KR)

(72) Inventors: Soojung BAE, Seoul (KR); Sanghyuk Koh, Seoul (KR); Eunjoo Kim, Seoul (KR); Changmo Yang, Gyeonggi-do (KR); Hyungmin Lee, Seoul (KR); Hoyoung Lee, Seoul (KR); Chulho Jang, Seoul (KR)

(73) Assignee: Samsung Electronics Co., Ltd.

(21) Appl. No.: 14/826,760

(22) Filed: Aug. 14, 2015

(30) Foreign Application Priority Data
Aug. 14, 2014 (KR) 10-2014-0105843

(51) Int. Cl. G06F 3/0484; G06F 3/0482; G06F 3/0481

(52) U.S. Cl. CPC G06F 3/04847; G06F 3/04817; G06F 3/0482

(57) ABSTRACT

Disclosed is a method for providing a user interface, in which an electronic device divides a display region into a main region and a sub-region and displays default information or event information on the sub-region. The electronic device determines whether there is a user input on the sub-region. If the user input moves more from the sub-region than a first distance, the electronic device extends the sub-region and displays detailed default information or detailed event information.

### PRIORITY

This application claims priority under 35 U.S.C. §119(a) to a Korean Patent Application filed on Aug. 14, 2014, in the Korean Intellectual Property Office and assigned Serial No. 10-2014-0105843, the contents of which are incorporated herein by reference.

### BACKGROUND OF THE INVENTION

1. Field of the Invention

The present invention relates to a method for providing a user interface in an electronic device having a divided display screen and to the electronic device for implementing the method.

2. Description of the Related Art

Due to the rapid growth of digital technologies, various electronic devices such as smart phones and tablet personal computers have become increasingly popular. In fact, the growth of such electronic devices has exceeded any growth in traditional television, computer and telephone environments, which has caused a mobile convergence stage to be reached, in which the fields of other type devices are incorporated.

For example, a mobile device typically supports various functions such as voice call, video call, Short Message Service (SMS), Multimedia Message Service (MMS), email, electronic organizer, digital camera, broadcasting receiver, music player, video player, Internet access, messenger, and Social Network Service (SNS).

However, the conventional art does not provide a convenient method of handling these converging technologies on an electronic device. Accordingly, there is a need in the art for an improved method and device for a user interface in converged digital technologies.

### SUMMARY OF THE INVENTION

Accordingly, the present invention has been made to address at least the problems and/or disadvantages described above and to provide at least the advantages described below.

Accordingly, an aspect of the present invention is to provide an electronic device and method for operating a user interface that provides a divided display screen in response to a specific event and displays various types of information on the divided screen in response to a user input.

According to an aspect of the present invention, a method for providing a user interface in an electronic device includes dividing a display region into a main region and a sub-region and displaying default information or event information on the sub-region; determining whether there is a user input on the sub-region; and if the user input moves from the sub-region more than a first distance, extending the sub-region and displaying detailed default information or detailed event information.

According to another aspect of the present invention, an electronic device includes a display unit including a touch panel capable of receiving a user input, and a control unit that controls the display unit to divide a display region into a main region and a sub-region, display default information or event information on the sub-region, and display a changed area of the sub-region in response to the user input, determines whether there is a user input at the sub-region, and if the user input moves from the sub-region more than a first distance, controls the display unit to extend the sub-region and display detailed default information or detailed event information on the sub-region.

### BRIEF DESCRIPTION OF THE DRAWINGS

The above and other aspects, features and advantages of the present invention will become more apparent from the following detailed description, when taken in conjunction with the accompanying drawings in which:

FIG. 1 is a block diagram illustrating an electronic device according to an embodiment of the present invention;

FIG. 2A illustrates a user interface provided in response to a specific event in an electronic device according to an embodiment of the present invention;

FIG. 2B is a perspective view illustrating an operation of providing a user interface in an electronic device having a bended or curved display according to an embodiment of the present invention;

FIG. 2C illustrates a user interface provided in response to a specific event in an electronic device according to another embodiment of the present invention;

FIG. 3A is a top view illustrating a sub-region of a divided display screen in an electronic device according to an embodiment of the present invention;

FIG. 3B is a perspective view illustrating a sub-region of a divided display screen in an electronic device having a bended or curved display according to an embodiment of the present invention;

FIG. 4A illustrates a method for providing a user interface of an electronic device according to an embodiment of the present invention;

FIG. 4B illustrates a method for providing a user interface of an electronic device according to another embodiment of the present invention;

FIG. 5 illustrates a method for providing a user interface of an electronic device according to still another embodiment of the present invention;

FIG. 6A illustrates a user interface provided in response to a user input in an electronic device according to an embodiment of the present invention;

FIG. 6B illustrates a user interface provided in response to a user input in an electronic device according to another embodiment of the present invention;

FIG. 7 illustrates a user interface provided in response to a user input in an electronic device according to still another embodiment of the present invention;

FIG. 8 illustrates a method for providing a user interface of an electronic device according to an embodiment of the present invention; and

FIG. 9 illustrates a user interface provided in response to a further specific event in an electronic device according to an embodiment of the present invention.

### DETAILED DESCRIPTION OF EMBODIMENTS OF THE INVENTION

Hereinafter, various embodiments of the present invention will be described with reference to the accompanying drawings. The embodiments may be in various forms and should not be construed as limited to the embodiments set forth herein. Rather, the disclosed embodiments are provided so that this disclosure fully conveys the scope of the invention to those skilled in the art. In the drawings, the same reference numerals may denote the same elements. Additionally, well known functions or structures may not be described or illustrated in detail to avoid obscuring the subject matter of the present invention.

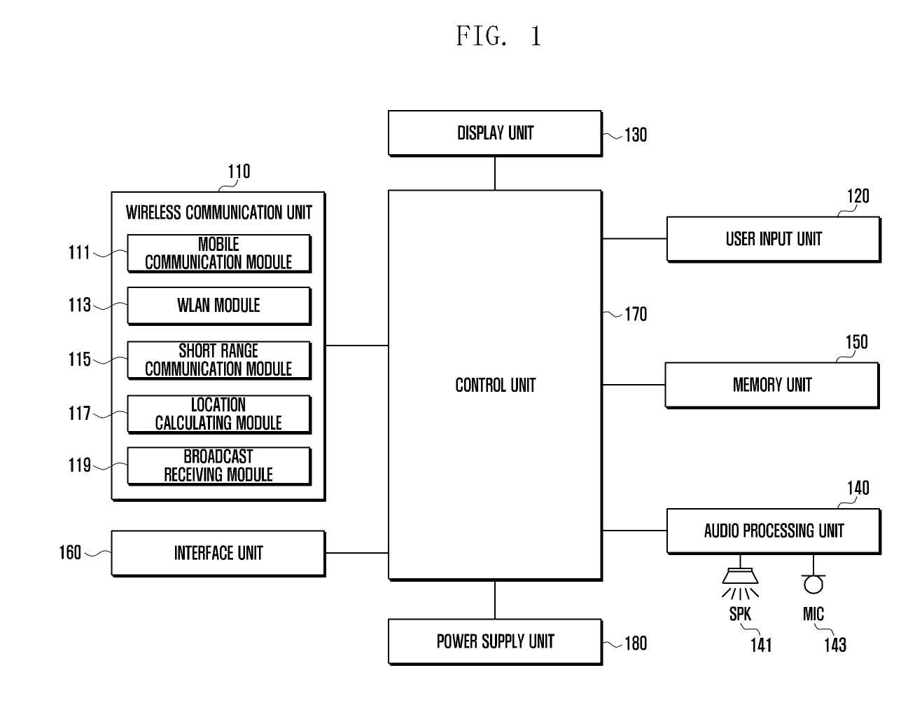

FIG. 1 is a block diagram illustrating an electronic device 100 according to an embodiment of the present invention.

The electronic device 100 includes a wireless communication unit 110, a user input unit 120, a display unit 130, an audio processing unit 140, a memory unit 150, an interface unit 160, a control unit 170, and a power supply unit 180. The electronic device 100 may be configured to include fewer or additional elements.

The wireless communication unit 110 includes at least one module capable of wireless communication between the electronic device 100 and both a wireless communication system and a network in which other electronic device is located. For example, the wireless communication unit 110 includes a mobile communication module 111, a Wireless Local Area Network (WLAN) module 113, a short-range communication module 115, a location-calculating module 117, and a broadcast-receiving module 119.

The mobile communication module 111 transmits or receives a wireless signal to or from at least one of base stations, other devices, and various servers such as an integration, provider, and content server in a mobile communication network. This wireless signal includes voice call, video call, or various types of data in connection with transmission and reception of a text or multimedia message. The mobile communication module 111 accesses at least one of the above servers under the control of the control unit 170 and receives a selected application which is usable in the electronic device 100.

The WLAN module 113 performs wireless Internet access and establishes a WLAN link with any other electronic device. The WLAN module 113 may be embedded in or attached to the electronic device 100. Well-known techniques such as Wi-Fi, Wireless broadband (Wibro), World interoperability for microwave access (Wimax), and High Speed Downlink Packet Access (HSDPA) may be used for wireless Internet access. The WLAN module 113 accesses at least one of the above servers under the control of the control unit 170 and receives a selected application that is usable in the electronic device 100. When a WLAN link is formed with any other electronic device, the WLAN module 113 transmits or receives a selected application to or from the linked electronic device.

The short-range communication module 115 is designed for short-range communication with such techniques as Bluetooth®, Bluetooth Low Energy (BLE), Radio Frequency Identification (RFID), Infrared Data Association (IrDA), Ultra WideBand (UWB), ZigBee, and Near Field Communication (NFC). When a short-range communication is connected to any other electronic device, the short-range communication module 115 transmits or receives a selected application to or from the connected electronic device.

The location-calculating module 117 obtains the location of the electronic device 100, such as a Global Positioning System (GPS) module. The location-calculating module 117 calculates information regarding time and distance from at least three base stations and, based on such information, calculates a current three-dimensional location including latitude, longitude and altitude through triangulation. Alternatively, the location-calculating module 117 calculates a real-time location of the electronic device 100 by receiving real-time data from at least three satellites. Any other suitable technique for obtaining the location of the electronic device 100 may be used.

The broadcast-receiving module 119 receives a broadcast signal such as TV, radio, and data and/or broadcast-related information such as information regarding a broadcast channel, a broadcast program, and a broadcast service provider, from an external broadcast management server through a broadcast channel.

According to embodiments of the present invention, the wireless communication unit 110 receives default information or event information from an external electronic device.

The user input unit 120 receives user's manipulations and creates input data for controlling the operation of the electronic device 100. The user input unit 120 may be selectively composed of a keypad, a dome switch, a touchpad, a jog wheel, a jog switch, and various sensors, for example. Additionally, the user input unit 120 may be formed of buttons installed on the exterior of the electronic device 100, some of which may be realized in a touch panel.

According to various embodiments of the present invention, default information or event information may be created in response to user's manipulations through the user input unit 120 and stored in the memory unit 150 under the control of the control unit 170.

The display unit 130 displays information processed in the electronic device 100. For example, when the electronic device 100 is in a call mode, the display unit 130 displays a User Interface (UI) or a Graphic UI (GUI) in connection with the call mode. Similarly, when the electronic device 100 is in a video call mode or a camera mode, the display unit 130 displays a received and/or captured image, UI or GUI.

The display unit 130 may be a Liquid Crystal Display (LCD), Thin Film Transistor-LCD (TFT-LCD), Light-Emitting Diode (LED), Organic LED (OLED), Active Matrix OLED (AMOLED), flexible display, bended or curved display, or 3-Dimensional (3D) display. Some of such displays may be realized as a transparent display.

When the display unit 130 is a bended or curved display, a panel of the display unit 130 may be extended to both lateral sides, corresponding to a bezel region, of the electronic device 100.

According to embodiments of the present invention, the display unit 130 displays a screen divided into first and second regions, and displays at least one of default information and event information on one of the first and second regions.

According to embodiments of the present invention, the display unit 130 displays a screen divided into a main region and a sub-region, and displays at least one of default information and event information on one of the main region and the sub-region.

In an embodiment, the display unit 130 displays, on the first region or the main region, information regarding a specific application or function being executed, and displays, on the second region or the sub-region, information regarding a specific occurring event by means of at least one of a text, thumbnail image, and icon.

In an embodiment, default information as well as event information may be displayed on the sub-region. For example, default information includes various types of information associated with a clock, a calendar, weather, a scheduler, a residual quantity of a battery, a network such as WiFi, a short-range communication such as NFC and Bluetooth®, entertainment such as a game or music, stocks, an exchange rate, a book, a recruit, a life, a map, news, and icons of frequently used applications. According to an embodiment, the display unit 130 displays default information on the sub-region and, when an event occurs, displays event information alone or together with the default information on the sub-region.

According to another embodiment, when a certain event occurs, the display unit 130 divides a display screen into two or more regions and displays event information on one of the divided display regions. If any touch-drag input moves more than a predetermined distance on or from the sub-region, the display unit 130 extends the sub-region in the direction of the touch-drag input. At this time, the electronic device 100 controls the display unit 130 to reconfigure the screen of the sub-region on the extended sub-region according to a predefined display policy. For example, this reconfiguration includes at least one of an increase and a rearrangement of information displayed on the sub-region. Additionally, if any touch-drag input moves more than a predetermined distance on or from the sub-region, the display unit 130 displays an execution screen of service, application or function associated with event information. The type and number of default information to be displayed on the sub-region may be selected by a user or determined in advance by a manufacturer.

In another embodiment, if any touch-drag input moves more than a predetermined distance, the display unit 130 extends a region displaying event information in the direction of the touch-drag input and further displays detailed event information on the extended region. Additionally, if any touch-drag input moves more than a predetermined distance, the display unit 130 displays an execution screen of service, application or function associated with event information.

When the display unit 130 forms a layered structure together with a touch panel capable of detecting a touch gesture, the display unit 130 may be used as an input unit as well as an output unit. The touch panel may be formed to convert a pressure applied to a certain point of the display unit 130 or a variation in capacitance produced at a certain point of the display unit 130 into an electric input signal. The touch panel may be formed to detect the pressure, location and area of a touch. When there is a touch input on the touch panel, a corresponding signal or signals may be transferred to a touch controller. The touch controller may then process such a signal or signals and transfer resultant data to the control unit 170. Therefore, the control unit 170 identifies which point of the display unit 130 is touched.

The audio processing unit 140 transmits to a speaker 141 an audio signal received from the control unit 170, and transmits to the control unit 170 an audio signal such as voice received from a microphone 143. Under the control of the control unit 170, the audio processing unit 140 converts an audio signal into an audible sound and outputs the audible sound to the speaker 141, and converts an audio signal received from the microphone 143 into a digital signal and outputs the digital signal to the control unit 170.

The speaker 141 outputs audio data received from the wireless communication unit 110 or stored in the memory unit 150 in a call, recording, media content playback, camera, or multi-window mode, for example. The speaker 141 outputs a sound signal associated with a particular function such as the reception of an incoming call, transmission of an outgoing call, playback of a music or video file, or an external output performed in the electronic device 100.

The microphone 143 processes a received sound signal into electric voice data in a call, recording, speech recognition, or camera mode, for example. In the call mode, the processed voice data is converted into a suitable form for transmission to a base station through the mobile communication module 111. The microphone 143 may have various noise-removal algorithms for removing noise from a received sound signal.

The memory unit 150 stores a program associated with processing and controlling operations of the control unit 170 and temporarily stores data inputted or to be outputted. The memory unit 150 may further store the frequency of use of a particular function such as a specific application, specific media content, or a specific phone number, the priority, and weight or preference of a particular function. The memory unit 150 also stores vibration and sound data having specific patterns to be outputted in response to a touch input on the touch screen.

According to an embodiment, the memory unit 150 stores detailed default or event information. When this information is displayed on a divided region, the memory unit 150 stores information regarding a display position where default information or event information is arranged on the divided region, together with a mapping relation to a service, application or function associated with the default or event information. The memory unit 150 also stores the type of content or icon associated with the default or event information.

The memory unit 150 includes at least one storage medium such as flash memory, hard disk, micro-type memory, card-type memory such as a Secure Digital (SD) or eXtream Digital (XD) card, Dynamic Random Access Memory (DRAM), Static RAM (SRAM), Read Only Memory (ROM), Programmable ROM (PROM), Electrically Erasable PROM (EEPROM), Magnetic RAM (MRAM), magnetic disk, and optical disk. The electronic device 100 interacts with any type of web storage that performs a storing function of the memory unit 150 on the Internet.

The interface unit 160 acts as a gateway to and from all external devices connected to the electronic device 100. The interface unit 160 receives data from an external device or transmits data of the electronic device 100 to such an external device. The interface unit 160 receives electric power from an external device and distributes it to respective elements in the electronic device 100. The interface unit 160 includes, for example, a wired/wireless headset port, a charger port, a wired/wireless data port, a memory card port, an audio input/output port, a video input/output port, an earphone port, and a port for connecting any device having an identification module. Namely, the interface unit 160 includes a suitable interface for a wired or wireless connection with an external device.

According to various embodiments, the interface unit 160 may be for receiving default information or event information from an external electronic device.

The control unit 170 controls the overall operation of the electronic device 100. For example, the control unit 170 performs a control process associated with a voice call, data communication, a video call, or an operation of applications in a multi-window environment. The control unit 170 may have a separate multimedia module for operating a multi-window function. In embodiments, this multimedia module may be embedded in the control unit 170 or formed separately from the control unit 170.

According to an embodiment, the control unit 170 controls the display unit 130 to display a main region and a sub-region, and to display default information or event information on the sub-region. Additionally, depending on the orientation of the electronic device 100 detected through the gyro sensor, the control unit 170 determines display positions of the main region and the sub-region and control the display unit 130 to display the main region and the sub-region based on the determined display positions. The main region displays thereon a function or an application, being currently executed, or display thereon an execution screen of a function included in the sub-region in response to a user input.

The control unit 170 controls the display unit 130 to extend the sub-region in response to a received user input. The control unit 170 determines whether a certain user input moves more than the first distance or the second distance. If a user input moves more than the first distance, the control unit 170 controls the display unit 130 to display detailed event information on the extended sub-region. If a user input moves more than the second distance, the control unit 170 executes a function, service or application associated with event information. Alternatively or additionally, if a user input moves more than the second distance, the control unit 170 controls the display unit 130 to display an execution screen of a function, service or application associated with event information.

The first distance and the second distance are compared to the extent of a movement produced by a user input on the display unit 130. The first distance may be shorter than the second distance. In this disclosure, the first distance may be replaced with the first location which is relatively close to the sub-region in comparison to the second distance. Similarly, the second distance may be replaced with the second location which is relatively far from the sub-region in comparison to the first distance.

If a new event occurs in a state of displaying event information, the control unit 170 controls the display unit 130 to further display event information regarding the new event on a divided display region. In this case, the control unit 170 determines whether a user input moving more than the first distance is released. If so, the control unit 170 controls the display unit 130 to display event information previous to the currently displayed event information regarding the new event.

According to another embodiment, the control unit 170 controls the display unit 130 to display the first screen which may be one of an idle, home, or application execution screen. Additionally or alternatively, if the electronic device 100 is in a power saving mode, the first screen may be in a dimmed state where a light source of the display unit 130 is adjusted to dim, or in a turn-off state where a light source of the display unit 130 is turned off. The control unit 170 determines whether a certain event occurs. In this disclosure, an event refers to an operation or occurrence which can be detected and processed by a program of the electronic device 100. According to embodiments, an event may be a notification of an incoming or missed call, a received SMS, MMS, email, or Instant Message (IM), an approaching schedule, or any other notification from an application or operating system using a push technique.

The control unit 170 determines whether a specific event occurs, and if an event occurs, controls the display unit 130 to divide a display screen into two or more display regions and to display event information on one of the divided display regions. Embodiments disclosed herein may be realized, using software, hardware, and a combination thereof, in any type of computer-readable recording medium. When of hardware, embodiments disclosed herein may be realized using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and any other equivalent electronic unit. In some cases, disclosed embodiments may be realized in just the control unit 170. When of software, embodiments disclosed herein may be realized using separate software modules that can each perform at least one of functions and operations discussed herein.

The power supply unit 180 receives electric power from an external or internal power source and supplies the electric power to respective elements of the electronic device 100 under the control of the control unit 170.

The electronic device 100 shown in FIG. 1 includes, but is not limited to, various types of devices that support a particular function disclosed herein and employ an Application Processor (AP), a Graphic Processing Unit (GPU), and a Central Processing Unit (CPU). For example, the electronic device 100 includes a tablet Personal Computer (PC), a smart phone, a digital camera, a Portable Multimedia Player (PMP), a media player, a portable game console, and a Personal Digital Assistant (PDA), including a mobile communication device that operates based on respective communication protocols of various communication systems.

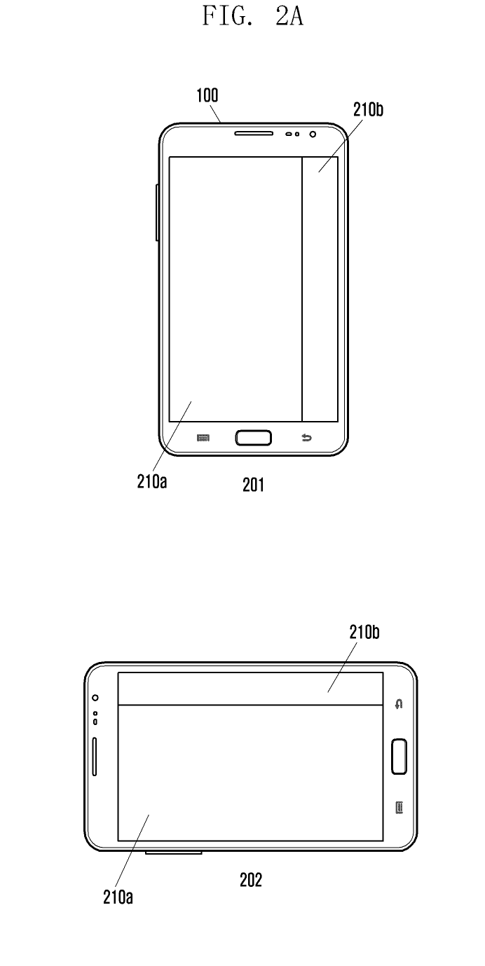

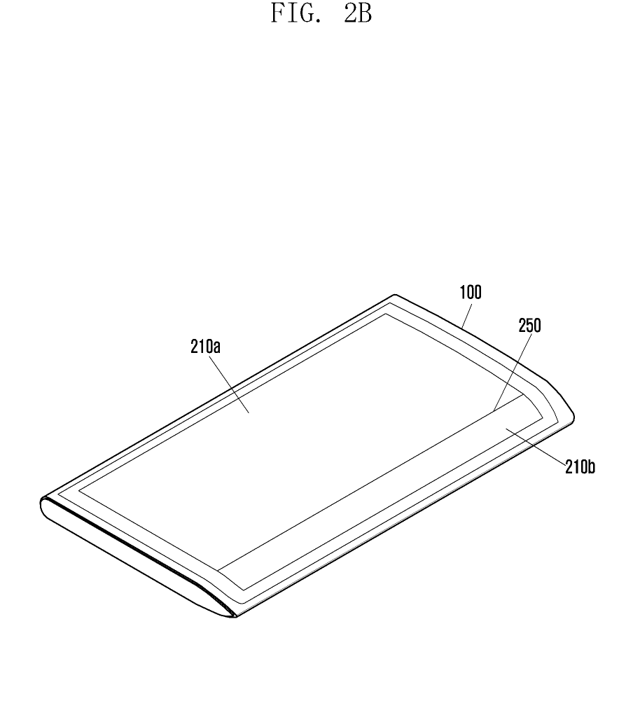

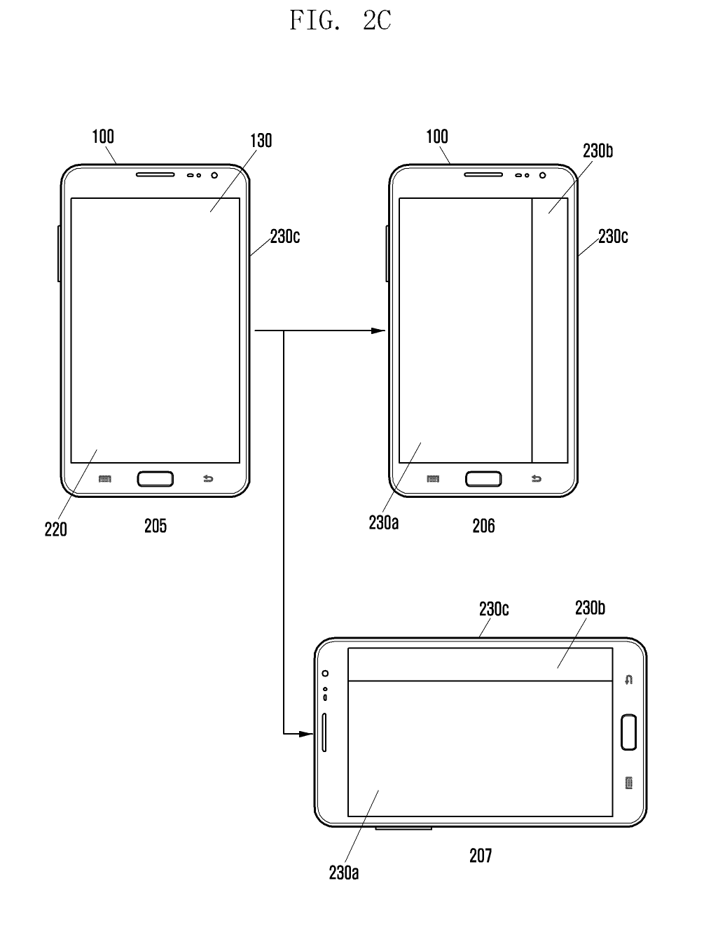

FIG. 2A illustrates a user interface provided in the electronic device 100 according to an embodiment of the present invention.

The electronic device 100 may further include a gyro sensor that can detect the orientation of the electronic device 100. The electronic device 100 determines a screen display mode depending on the detected orientation. Screenshot 201 of FIG. 2A illustrates a portrait mode of the electronic device 100, and screenshot 202 of FIG. 2A illustrates a landscape mode of the electronic device 100.

In both modes as shown in FIG. 2A, the electronic device 100 controls the display unit 130 to display information regarding a currently executed application or function on a main region 210a and to display default information or event information on a sub-region 210b.

When event information is displayed on the sub-region 210b, the electronic device 100 displays the event information by means of at least one of text, thumbnail image, and icon.

Additionally, the electronic device 100 displays, on the sub-region 210b, default information which is at least one type of information associated with a clock, a calendar, weather, a scheduler, a residual quantity of a battery, a network, a short-range communication, entertainment such as game or music, stocks, an exchange rate, a book, a recruit, a life, a map, a news, and icons of frequently used applications, for example. According to an embodiment, the display unit 130 displays default information on the sub-region 210b and, when an event occurs, displays event information alone or together with the default information on the sub-region 210b. The type and number of default information to be displayed on the sub-region 210b may be selected by a user or determined in advance by a manufacturer.

FIG. 2B is a perspective view illustrating an operation of providing a user interface in the electronic device 100 having a bended or curved display according to an embodiment of the present invention.

When the display unit 130 is formed of a bended or curved display, the main region 210a and the sub-region 210b are distinguished from each other at or near an inner edge 250 of a bended or curved portion. For example, the main region 210a is assigned to a flat and relatively wider portion of the display unit 130, and the sub-region 210b is assigned to a bended and relatively narrower portion of the display unit 130.

FIG. 2C illustrates a user interface provided in response to a specific event in the electronic device 100 according to another embodiment of the present invention.

Screenshot 205 of FIG. 2C illustrates a display state of the electronic device 100 when no event occurs in the electronic device 100.

In this display state as shown in screenshot 205, the electronic device 100 displays the first screen 220 on the display unit 130, such as an idle screen, a home screen, or an application execution screen. Additionally or alternatively, if the electronic device 100 is in a power saving mode, the first screen 220 may be in a dimmed state where a light source of the display unit 130 is adjusted to be dim, or in a turn-off state where a light source of the display unit 130 is turned off.

Screenshots 206 and 207 of FIG. 2C illustrate a display state of the electronic device 100 when a certain event occurs in the electronic device 100.

As previously discussed, the electronic device 100 may further include a gyro sensor that detects the orientation of the electronic device 100. The electronic device 100 determines a screen display mode depending on the detected orientation. Screenshot 206 of FIG. 2C illustrates a portrait mode of the electronic device 100, and screenshot 207 of FIG. 2C illustrates a landscape mode of the electronic device 100.

When an event occurs in the electronic device 100, the electronic device 100 divides a display screen of the display unit 130 into two or more display regions as shown in screenshots 206 and 207 of FIG. 2C. The electronic device 100 then displays event information on one of the divided display regions.

In this disclosure, an event refers to an operation or occurrence which can be detected and processed by a program of the electronic device 100, such as notification of an incoming call, missed call, received SMS, MMS, or email, received Instant Message (IM), an approaching schedule, or any other notification from an application or operating system using a push technique.

In a state as shown in screenshot 206 or 207 of FIG. 2C, the electronic device 100 divides the first screen 220 into the second screen 230a and the third screen 230b. For example, the second screen 230a is the main region 210a as shown in screenshot 206, and the third screen 230b is the sub-region 210b as shown in screenshot 207.

The second screen 230a is displayed before the occurrence of an event in the electronic device 100. In an embodiment, the second screen 230a corresponds to the first screen 220 displayed before the occurrence of an event. For example, the first screen 220 may be reduced in size to the second screen 230a.

In another example, the second screen 230a remains in a full screen of the first screen 220, and the third screen 230b is overlaid on the second screen 230a transparently or semi-transparently.

The third screen 230b displays information regarding an occurring event and is disposed near and along the bezel region 230c of the electronic device 100, such as one of four peripheral parts of the display unit 130 adjacent to the bezel region. The third screen 230b may have a bar shape, a banner shape, a ribbon shape, or a strap shape, each of which having an elongated form.

In an embodiment, as shown in screenshot 206 of FIG. 2C, the third screen 230b is disposed in the shape of a bar, banner, ribbon or strap at the right part of the display unit 130 adjacent to the bezel region, or may be displayed at the left, top or bottom part of the display unit 130 adjacent to the bezel region.

In an embodiment, as shown in screenshot 207 of FIG. 2C, the third screen 230b is disposed in the shape of a bar, banner, ribbon or strap at the top part of the display unit 130 adjacent to the bezel region, or may be displayed at the bottom, left, or right part of the display unit 130 adjacent to the bezel region.

When the display unit 130 is formed of a bended or curved display, the second screen 230a and the third screen 230b are distinguished from each other at or near an inner edge of a bended portion. For example, the second screen 230a is assigned to a flat and relatively wider portion of the display unit 130, and the third screen 230b is assigned to a bended and relatively narrower portion of the display unit 130.

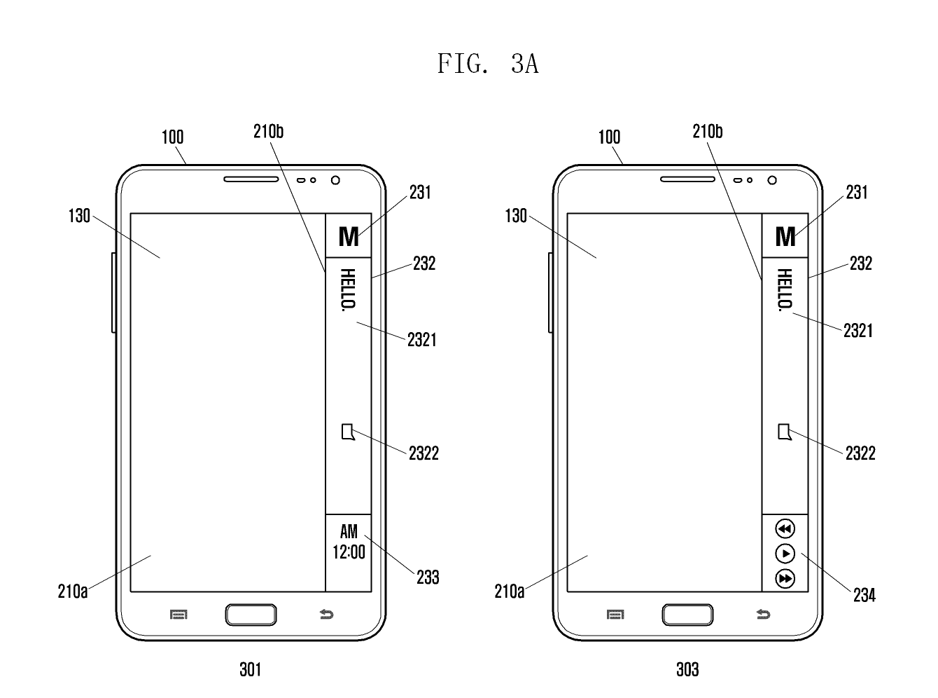

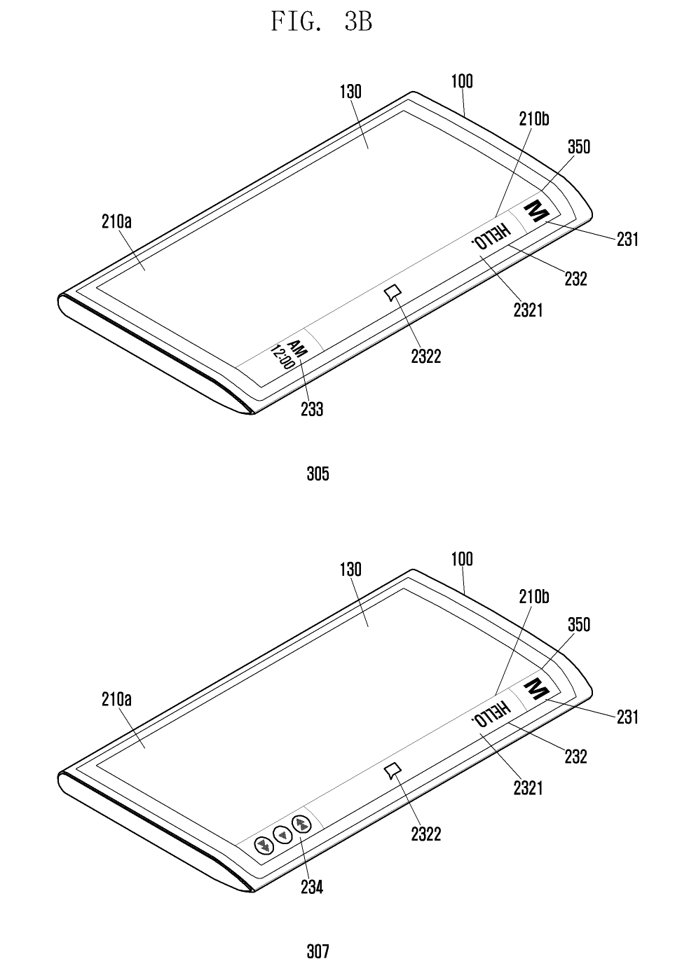

FIG. 3A illustrates a sub-region of a divided display screen in an electronic device 100 according to an embodiment of the present invention.

In a state as shown in screenshots 301 and 303 of FIG. 3A, the electronic device 100 divides the screen displayed on the display unit 130 into the main region 210a and the sub-region 210b. In screenshot 301, the sub-region 210b includes an icon display region 231, a content display region 232, and/or a time display region 233.

The icon display region 231 displays an icon representative of a service of the electronic device 100 associated with event information. Such an icon is disposed in the center of the icon display region 231. For example, an icon ‘M’ is displayed on the icon display region 231, as shown.

The content display region 232 displays at least one of content 2321, such as text, a number or a thumbnail image, and a Graphical User Interface (GUI) 2322 representing a function associated with event information, such as a message. The time display region 233 displays an event occurrence time or a current time.

According to an embodiment, the electronic device 100 displays part of information, rather than the entire information, associated with an occurring event as content 2321 on the content display region 232, for simplicity and ease of viewing to the user.

For example, the electronic device 100 receives an event containing, as content, an IM stating “Hello. This is a bank.”, through an SNS having a representative icon ‘M’ at 12:00 a.m. The electronic device 100 then divides the screen into the main region 210a and the sub-region 210b and displays the following information on the sub-region 210b.

Specifically, the electronic device 100 displays the representative icon ‘M’ on the icon display region 231 and displays, as the content 2321, ‘Hello’ only among “Hello. This is a bank.” on the content display region 232. The electronic device 100 displays the event occurrence time 12:00 a.m. on the time display region 233.

In screenshot 303 of FIG. 3A, the sub-region 210b includes the icon display region 231, the content display region 232, and/or a function display region 234. Screenshots 301 and 303 are different from each other only in terms of the time display region 233 and the function display region 234.

The function display region 234 displays a function of a service associated with event information or a function of a service being executed in the main region 210a. For example, if a service executed in the main region 210a is associated with music or video, a control function for music or video may be displayed.

FIG. 3B is a perspective view illustrating a sub-region of a divided display screen in an electronic device 100 having a bended or curved display according to an embodiment of the present invention.

In screenshot 305 of FIG. 3B, the electronic device 100 divides the screen displayed on the display unit 130 into the main region 210a and the sub-region 210b which are distinguished from each other at or near an inner edge 350 of a bended portion. The detailed matter of the sub-region 210a is the same as that discussed in FIG. 3A. Screenshots 305 and 307 of FIG. 3B are different from each other only in terms of the time display region 233 and the function display region 234.

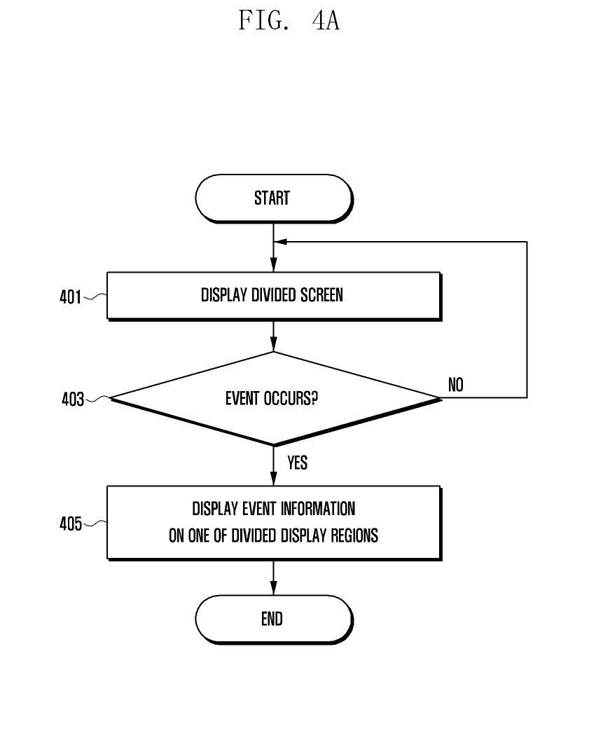

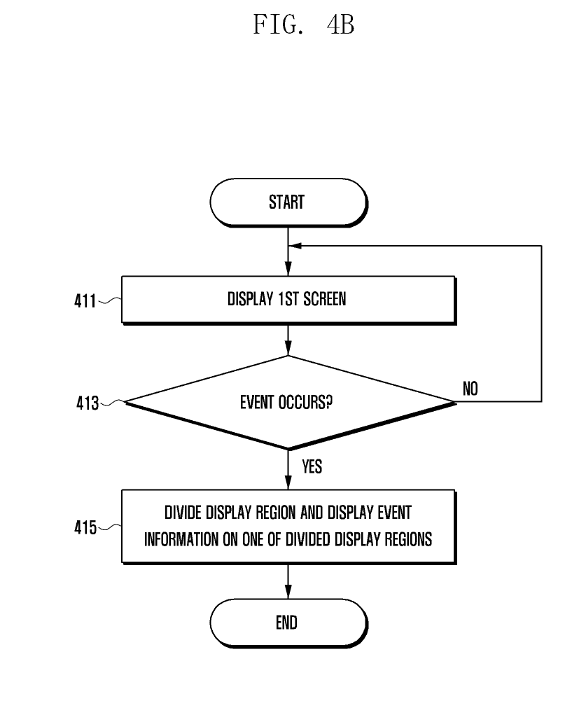

FIG. 4A illustrates a method for providing a user interface of an electronic device 100 according to an embodiment of the present invention.

At step 401, the electronic device 100 displays a divided screen on the display unit 130. Specifically, the electronic device 100 divides the screen into the main region 210a and the sub-region 210b and displays the divided screen on the display unit 130.

At step 403, the electronic device 100 determines whether an event occurs, wherein an event as described herein has been previously discussed in reference to FIG. 2C.

If it is determined at step 403 that no event occurs, the electronic device 100 returns to step 401 and continuously displays the divided screen.

If an event occurs, the electronic device 100 displays event information on the sub-region 210b of the display unit 130 at step 405.

At this step 405, the electronic device 100 determines a screen display mode, namely a portrait mode or a landscape mode, depending on the orientation thereof detected through the gyro sensor. The electronic device 100 then displays the divided screen according to the determined display mode.

If a new event occurs at step 403 while default information or event information is displayed on the sub-region 210b, the electronic device 100 displays information regarding the occurring event on the sub-region 210b.

The sub-region 210b for displaying event information includes at least one of the icon display region and the content display region as previously discussed.

The icon display region displays an icon representative of a service associated with the event information. Such an icon is disposed in the center of the icon display region. The content display region displays content, such as text or number, and a GUI representing a function associated with the event information.

According to another embodiment, at step 405, the electronic device 100 displays part of information, rather than the entire information, associated with the occurring event as content on the content display region.

FIG. 4B illustrates a method for providing a user interface of an electronic device 100 according to another embodiment of the present invention.

At step 411, the electronic device 100 displays the first screen 220 on the display unit 130. The first screen 220 may be one of an idle screen, a home screen, or an application execution screen. Additionally or alternatively, if the electronic device 100 is in a power saving mode, the first screen 220 may be in a dimmed state where a light source of the display unit 130 is adjusted to be dim, or in a turn-off state where a light source of the display unit 130 is turned off.

At step 413, the electronic device 100 determines whether an event occurs, wherein an event has been previously discussed.

If it is determined at step 413 that no event occurs, the electronic device 100 returns to step 411 and continuously displays the first screen 220.

If an event occurs, the electronic device 100 divides the first screen 220 into display regions and displays event information on one of the display regions of the display unit 130 at step 415.

The electronic device 100 determines a screen display mode, namely a portrait mode or a landscape mode at step 415, depending on the orientation thereof detected through the gyro sensor, and then displays the divided display regions according to the determined display mode.

According to another embodiment, at step 415, the electronic device 100 divides a first display screen into a main region and a sub-region. The main region corresponds to the first screen 220 displayed before the occurrence of an event. For example, at step 415, the electronic device 100 reduces the size of the first screen 220 to a predefined size of the main region.

In another example, at step 415, the electronic device 100 controls the main region to remain in a full screen of the first screen 220 and controls the sub-region to be overlaid on the main region transparently or semi-transparently.

The sub-region displays information regarding an occurring event, and is disposed near and along the bezel region of the electronic device 100 such as at one of four peripheral parts of the display unit 130 adjacent to the bezel region. The sub-region may have a bar shape, a banner shape, a ribbon shape, or a strap shape, each of which having an elongated form.

The sub-region for displaying event information includes at least one of the icon display region and the content display region as previously discussed.

The icon display region displays an icon representative of a service associated with the event information. Such an icon is disposed in the center of the icon display region. The content display region displays content, such as text or number, and a GUI representing a function associated with the event information.

According to an embodiment, at step 415, the electronic device 100 displays part of information, rather than the entire information, associated with the occurring event as content on the content display region.

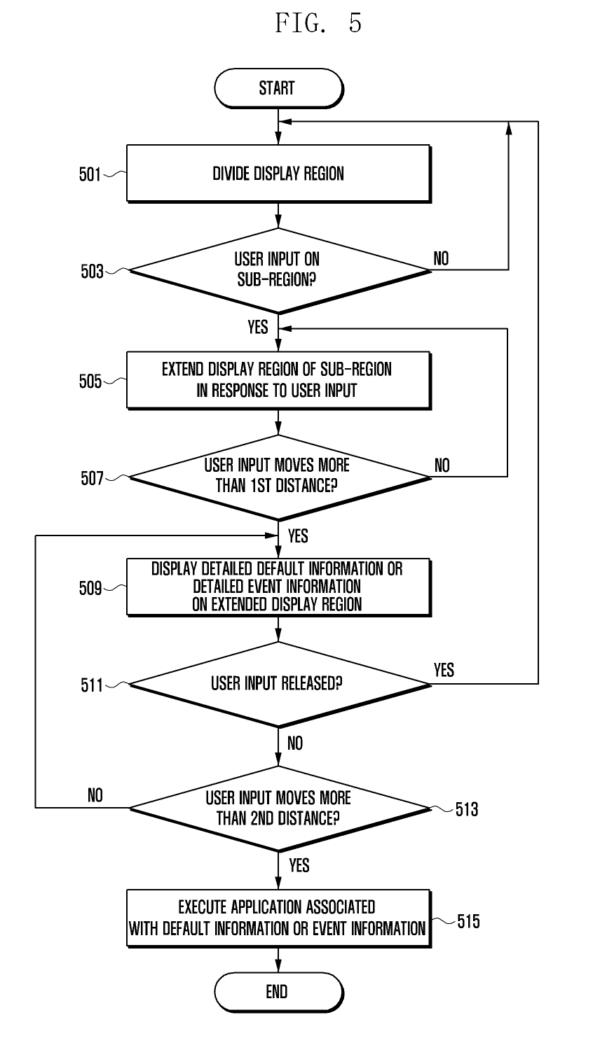

FIG. 5 illustrates a method for providing a user interface of an electronic device 100 according to still another embodiment of the present invention.

At step 501, the electronic device 100 divides a display region into first (i.e., main) and second (i.e., sub-) regions and displays the first and second regions on the display unit 130. The sub-region displays information regarding an occurring event, and is disposed near and along the bezel region of the electronic device 100. When the display unit 130 is formed of a bended or curved display, the sub-region is displayed at one lateral side of the electronic device 100.

At step 501, the electronic device displays information regarding an executed function or application on the main region and displays default information or event information on the sub-region.

At step 503, the electronic device 100 determines whether there is a user input on the sub-region, such as a touch and drag input on the sub-region. For example, a user touches or taps a certain point on the sub-region and then drags from one bezel region adjacent to the sub-region to the opposite bezel region.

If there is no user input on the sub-region at step 503, the electronic device 100 returns to step 501 and displays default or event information on one of the divided regions of the display unit 130.

If there is a user input on the sub-region at step 503, the electronic device 100 extends the sub-region in response to the user input such as a drag input at step 505.

At step 507, the electronic device 100 determines whether the user input moves more than the first distance. Step 505 is performed until it is determined at step 507 that the user input moves more than the first distance.

When it is determined that the user input moves more than the first distance, the electronic device 100 displays detailed default or event information on the extended sub-region at step 509. For example, at step 509, the electronic device 100 extends a display region for content in proportion to a moving distance of the user input, and displays an increased number of contents or rearranges contents by reconfiguring a display policy regarding default information or detailed information.

At step 511, the electronic device 100 determines whether the user input is released.

If it is determined at step 511 that the user input is released, the electronic device 100 returns to step 501 and displays default or event information on the sub-region of the display unit 130. For example, when the user input is released at step 511, the electronic device 100 re-displays the previous sub-region before it is extended. In this case, a speed of return from the extended sub-region to the previous sub-region may be proportional to a distance or acceleration of the user input. A longer user input may require a faster return to the previous sub-region when the user input is released.

The electronic device 100 displays such a return process, i.e., a process of reducing the area of the extended sub-region to that of the previous sub-region.

Since a return speed of the sub-region is proportional to a distance of the user input as previously discussed, the electronic device 100 offers a visual effect as if tension is applied to the sub-region.

Additionally, in such a return process, the electronic device 100 offers graphics or animation as if a scroll or roller blind is restored to the original form by a certain force such as tension.

If it is determined at step 511 that the user input is not released, the electronic device 100 determines at step 513 whether the user input moves more than the second distance.

As discussed earlier, the first distance and the second distance refer to the extent of a movement produced by a user input on the display unit 130. When a moving distance of the user input, such as a drag distance of a touch and drag input, exceeds the first distance or the second distance, the electronic device 100 changes a display policy regarding contents on the sub-region and/or executes a function, service or application associated with default or event information.

Additionally, the first distance refers to the first location relatively close to the sub-region, and similarly, the second distance refers to the second location relatively far from the sub-region. For example, if the display unit 130 is divided into three equal parts, the first location is placed one-third of the distance from the bezel region near the sub-region, and the second location is placed two-thirds of the distance from the bezel region near the sub-region.

If it is determined at step 513 that the user input does not move more than the second distance, the electronic device 100 returns to step 509 and displays detailed default or event information on the extended sub-region.

When it is determined that the user input moves more than the second distance, the electronic device 100 executes a function, service or application associated with default or event information at step 515, and may further display an execution screen of the function, service or application associated with default information or event information.

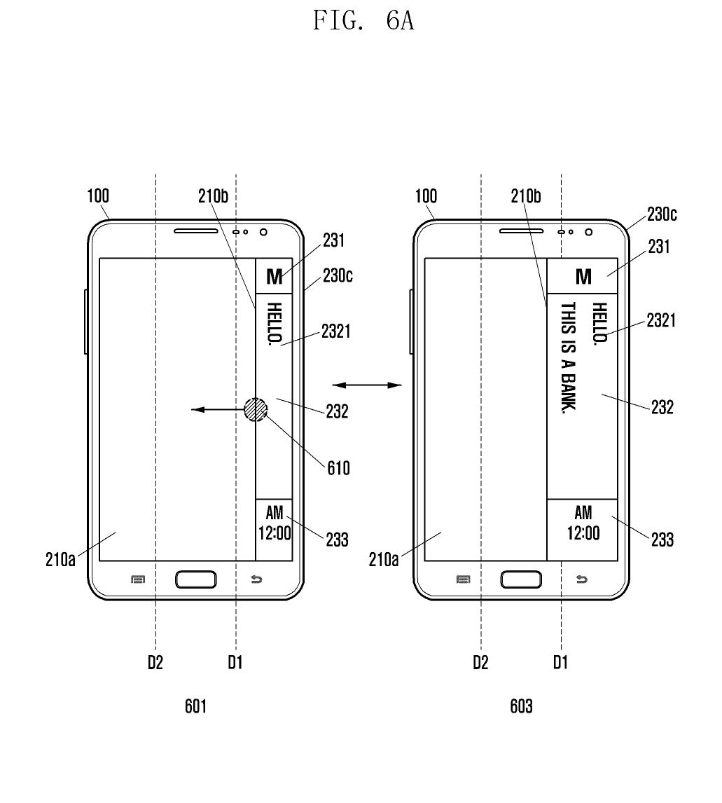

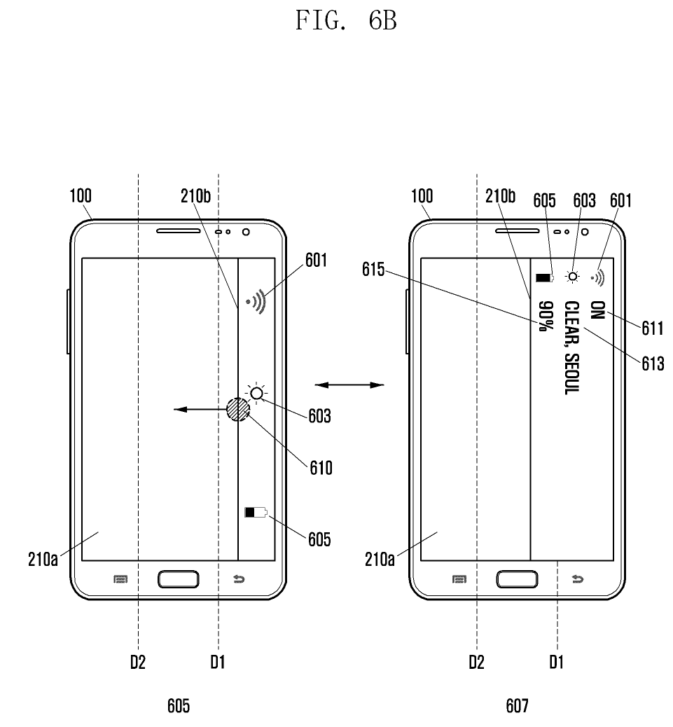

FIG. 6A illustrates a user interface provided in response to a user input in an electronic device 100 according to an embodiment of the present invention.

As shown in screenshot 601 and 603 of FIG. 6A, the electronic device 100 divides a display screen into the main region 210a and the sub-region 210b. The sub-region 210b displays default information or information regarding an occurring event. The sub-region 210b may be disposed near and along the bezel region 230c of the electronic device 100. FIG. 6A illustrates examples of displaying event information on the sub-region 210b.

The electronic device 100 determines whether there is a user input 610 on the sub-region 210b. This user input 610 may be a touch and drag input on the sub-region 210b. For example, a user touches or taps a certain point on the sub-region 210b and drags in the left direction from one bezel region adjacent to the sub-region 210b to the opposite bezel region, namely toward the main region 210a.

The electronic device 100 extends the sub-region 210b in response to the user input 610 as shown in screenshot 603.

If it is determined that the user input 610 moves in the left direction more than the first distance D1, the electronic device 100 displays detailed default information or detailed event information on the extended sub-region. For example, the electronic device 100 extends a display region for content in proportion to a moving distance of the user input. As shown in screenshot 601, the electronic device 100 displays only ‘Hello’ on the content display region 232 before the user input 610 moves more than the first distance D1. However, if the user input 610 moves in the left direction more than the first distance D1 as shown in screenshot 603, the electronic device 100 further displays ‘This is a bank’ in addition to ‘Hello’ on the content display region 232. When the sub-region 210b is disposed at the right bezel region of the electronic device 100 as shown, contents are displayed in an optimized form for reading when the electronic device 100 is rotated in a counter-clockwise direction. If the sub-region 210b is disposed at the left bezel region of the electronic device 100, contents are displayed in an optimized form for reading when the electronic device 100 is rotated in a clockwise direction. If the sub-region 210b is disposed at the top or bottom bezel region of the electronic device 100, contents are displayed in an optimized form for reading without rotation of the electronic device 100.

Although the icon display region 231 or the time display region 233 is scaled-up in size, an icon or time displayed on the icon display region 231 or the time display region 233 maintains an original size and is located at the center of the icon display region 231 or the time display region 233. In another embodiment, an icon or time displayed on the icon display region 231 or the time display region 233 may be changed in size according to the scale-up or scale-down of the sub region 210b.

If it is determined that the user input 610 is released, the electronic device 100 re-displays the previous sub-region in the pre-extended form. That is, the electronic device 100 changes a state of displaying default information or event information as shown in screenshot 603 to a state of displaying default information or event information as shown in screenshot 601. In this case, a speed of return from the extended sub-region to the previous sub-region is proportional to a distance or acceleration of the user input.

FIG. 6B illustrates a user interface provided in response to a user input in an electronic device 100 according to another embodiment of the present invention.

As shown in screenshot 605 and 607 of FIG. 6B, the electronic device 100 divides a display screen into the main region 210a and the sub-region 210b. The sub-region 210b displays default information or information regarding an occurring event. The sub-region 210b is disposed near and along the bezel region of the electronic device 100. FIG. 6B illustrates examples of displaying default information on the sub-region 210b.

The electronic device 100 determines whether there is a user input 610 on the sub-region 210b. This user input 610 may be a touch and drag input on the sub-region 210b. For example, a user can touch or tap a certain point on the sub-region 210b and drags from one bezel region adjacent to the sub-region 210b to the opposite bezel region, namely toward the main region 210a.

The electronic device 100 extends the sub-region 210b in response to the user input 610 as shown in screenshot 607.

If it is determined that the user input 610 moves more than the first distance D1, the electronic device 100 displays detailed default or event information on the extended sub-region. For example, the electronic device 100 extends a display region for content in proportion to a moving distance of the user input.

For example, before the user input 610 moves more than the first distance D1 as shown in screenshot 605, the electronic device 100 displays a network-related representative icon or thumbnail image 601, a weather-related representative icon or thumbnail image 603, and a battery-related representative icon or thumbnail image 605, as default information, on the sub-region 210b. The type and number of default information to be displayed on the sub-region 210b may be selected by a user or determined in advance by a manufacturer.

If the user input 610 moves to the left more than the first distance D1 as shown in screenshot 607, the electronic device 100 may enlarge the displayed respective icons or images 601, 603 and 605. The electronic device 100 further displays detailed information regarding a network, such s an ON state, 611, weather such as “Clear in Seoul” 613, or a residual quantity of a battery such as “90%” 615.

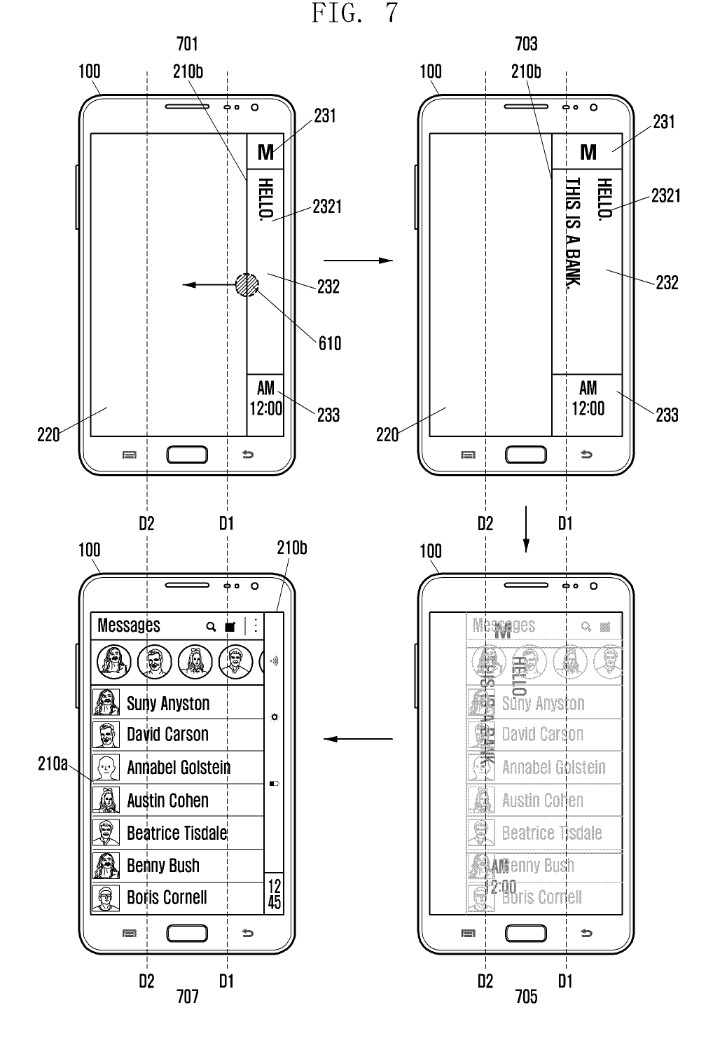

FIG. 7 illustrates a user interface provided in response to a user input in an electronic device 100 according to still another embodiment of the present invention.

Screenshots 701 and 703 of FIG. 7 correspond to screenshots 601 and 603 of FIG. 6A as previously discussed. FIG. 7 illustrates examples of displaying event information on the sub-region 210b.

In screenshots 705 and 707 of FIG. 7, if it is determined that the user input 610 moves to the left from the sub-region 210b more than the second distance D2, the electronic device 100 executes a function, service or application associated with default or event information and displays an execution screen of the function, service or application associated with default or event information.

Specifically, when it is determined that the user input 610 moves to the left from the sub-region 210b more than the second distance D2, the electronic device 100 displays an execution screen of the function, service or application associated with default information or event information as shown in screenshot 705. When this execution screen is displayed, the extended sub-region may be overlaid. The execution screen may fade in, and the extended sub-region may fade out. Therefore, as shown in screenshot 707, only the execution screen is displayed clearly.

As discussed earlier, the first distance D1 and the second distance D2 refer to the extent of a movement produced by a user input on the display unit 130 from the sub-region 210b. Additionally, the first distance D1 refers to the first location relatively close to the sub-region in comparison to the second distance D2, and the second distance D2 refers to the second location relatively far from the sub-region in comparison to the first distance D1. For example, if the display unit 130 is divided into three equal parts, the first distance D1 corresponds to the first location placed one-third of the distance from the bezel region near the sub-region, and the second distance D2 corresponds to the second location placed two-thirds of the distance from the bezel region near the sub-region.

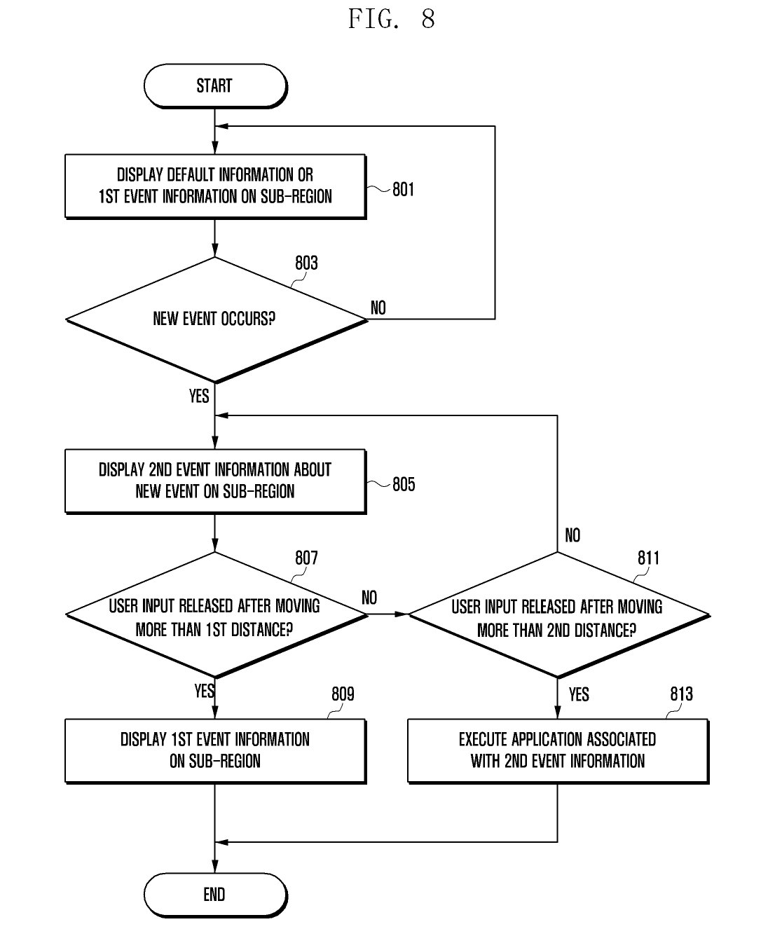

FIG. 8 illustrates a method for providing a user interface of an electronic device 100 according to an embodiment of the present invention.

At step 801, the electronic device 100 displays the main region and the sub-region into which the display screen is divided, and displays default information or the first event information regarding a previously-occurring event on the sub-region.

At step 803, the electronic device 100 determines whether a new event occurs. If no new event occurs, the electronic device 100 returns to step 801.

If a new event occurs, the electronic device 100 further displays the second event information regarding the new event on the divided display region at step 805. For example, the electronic device 100 overlays the second event information on the first event information displayed on the sub-region.

At step 807, the electronic device 100 determines whether the user input is released after moving more than the first distance. Specifically, at step 807, the electronic device 100 displays the detailed second event information on the extended sub-region when the user input moves from the sub-region more than the first distance, and proceeds to step 809 when the user input is released after a movement more from the sub-region than the first distance.

Specifically, at steps 801 to 807, the electronic device 100 displays event information regarding the newest event on the uppermost layer of the sub-region. When detailed information regarding event information on the uppermost layer is checked, the electronic device 100 displays event information located on the next upper layer under the uppermost layer.

If the user input is released after moving from the sub-region more than the first distance, the electronic device 100 displays the first event information on the sub-region of the display unit 130 at step 809.

If the user input is not released after moving from the sub-region more than the first distance, the electronic device 100 proceeds to step 811 and determines whether the user input is released after moving more than the second distance.

If the user input is released after moving from the sub-region more than the second distance, the electronic device proceeds to step 813 and executes a function, service or application associated with the second event information. For example, at step 813, the electronic device 100 displays an execution screen of the function, service or application associated with the second event information.

If the user input is not released after moving from the sub-region more than the second distance, the electronic device 100 returns to step 805.

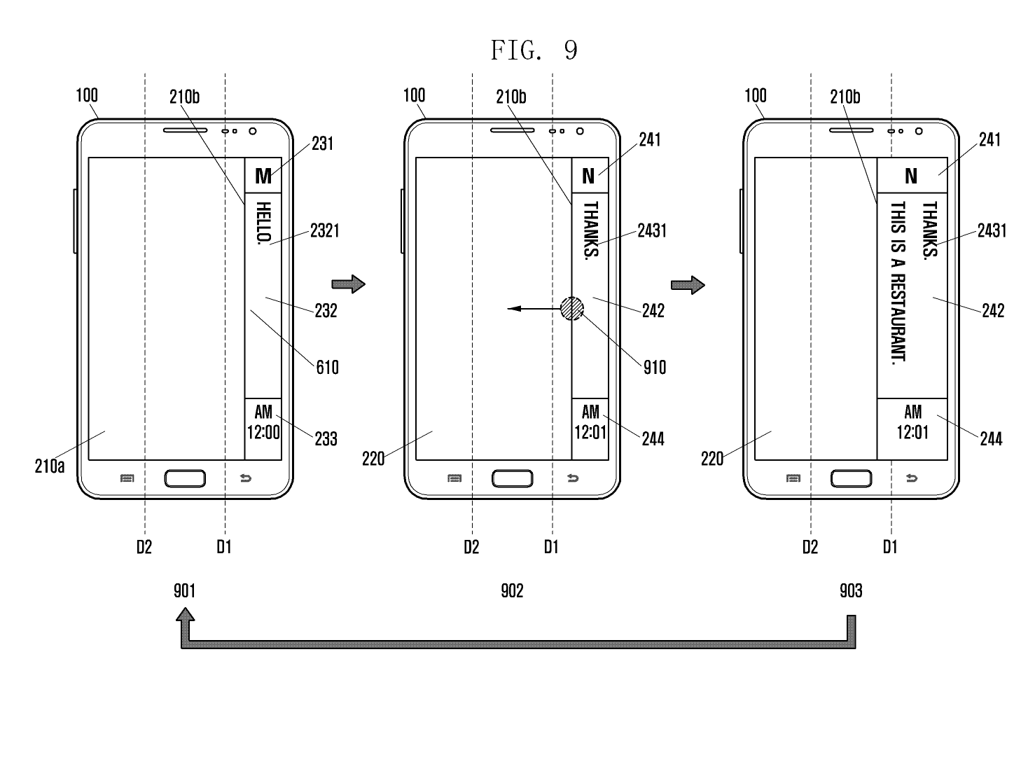

FIG. 9 illustrates a user interface provided in response to a further specific event in an electronic device 100 according to an embodiment of the present invention.

As shown in screenshot 901 of FIG. 9, the electronic device 100 divides a display screen into the main region 210a and the sub-region 210b. The sub-region 210b displays default information or the first event information and is disposed near and along the bezel region of the electronic device 100.

Regarding the first event information, the sub-region 210b includes the icon display region 231, the content display region 232, and/or the time display region 233. The icon display region 231 displays an icon representative of a service associated with the first event information.

For example, the electronic device 100 receives the first event information containing, as content, an IM, “Hello. This is a bank.”, through an SNS having a representative icon ‘M’ at 12:00 a.m. The electronic device 100 then divides the screen into the main region 210a and the sub-region 210b and displays the representative icon ‘M’ on the icon display region 231 and displays, as the content 2321, ‘Hello’ only among “Hello. This is a bank.” on the content display region 232. The electronic device 100 displays the event occurrence time, 12:00 a.m. on the time display region 233.

If a new event occurs as shown in screenshot 903 of FIG. 9, the electronic device 100 further displays the second event information regarding the new event on the divided display region. For example, the electronic device 100 overlays the second event information on the first event information displayed on the sub-region.

Regarding the second event information, the sub-region 210b includes an icon display region 241, a content display region 242, and/or a time display region 244. The icon display region 241 displays an icon representative of a service associated with the second event information.

For example, the electronic device 100 receives the second event information containing, as content, an IM, “Thanks. This is a restaurant.”, through an SNS having a representative icon ‘N’ at 12:01 a.m. The electronic device 100 overlays the second event information on the first event information displayed on the sub-region 210b, by displaying the representative icon ‘N’ on the icon display region 241 and displaying, as the content 2431, ‘Thanks’ only among “Thanks. This is a restaurant.” on the content display region 242. The electronic device 100 displays the event occurrence time, 12:01 a.m. on the time display region 244.

As shown in screenshot 905 of FIG. 9, the electronic device 100 determines whether the user input 910 is released after moving from the sub-region more than the first distance D1. Specifically, the electronic device 100 displays the detailed second event information on the extended sub-region when the user input moves from the sub-region more than the first distance, and displays the first information as shown in screenshot 901 when the user input is released after a user input movement from the sub-region more than the first distance.

Specifically, the electronic device 100 displays event information regarding the newest event on the uppermost layer of the sub-region. When detailed information regarding event information on the uppermost layer is checked, the electronic device 100 displays event information located on the next upper layer under the uppermost layer.

As fully discussed hereinbefore, the electronic device and method according to the present invention provide a more convenient interface for a user by displaying event information on a divided display region and, depending on a moving distance of a user input, displaying the details of the event information or executing a function associated with the event information.

While the present invention has been particularly shown and described with reference to an embodiment thereof, it will be understood by those skilled in the art that various changes in form and details may be made therein without departing from the spirit and scope of the present invention as defined by the appended claims.

What is claimed is:

1. A method for providing a user interface in an electronic device, the method comprising:
dividing a display region into a main region and a sub-region and displaying default information or event information on the sub-region;
determining whether there is a user input on the sub-region; and
if the user input moves from the sub-region more than a first distance, extending the sub-region and displaying detailed default information or detailed event information.

2. The method of claim 1, further comprising:
if the user input moves from the sub-region more than the first distance, displaying additional information associated with the default information or the event information displayed on the sub-region, rearranging the default information or the event information, or enlarging an icon or thumbnail image included in the default information or the event information.

3. The method of claim 1, further comprising:
if the user input moves more than a second distance, executing one of a service, a function or an application associated with the default information or the event information, or displaying an execution screen of the service, function or application.

4. The method of claim 3, wherein the second distance is farther from the sub-region than the first distance.

5. The method of claim 4, wherein when the execution screen of the service, function or application is displayed, the execution screen fades in and the detailed default information or the detailed event information fades out.

6. The method of claim 4, further comprising:
if the user input is released after moving from the sub-region more than the first distance and less than the second distance, reducing a size of the extended sub-region to a pre-extended size.

7. The method of claim 6, wherein the size of the extended sub-region is reduced at a speed proportional to a moving distance of the user input.

8. The method of claim 4, further comprising:
if a new event occurs, overlaying new event information on the default information or the event information displayed on the sub-region.

9. The method of claim 8, further comprising:
if the user input is released after moving from the sub-region more than the first distance and less than the second distance, displaying the event information instead of the new event information on the sub-region.

10. The method of claim 1, wherein the sub-region includes at least one of an icon display region, a content display region, a time display region, and a function display region.

11. An electronic device comprising:
a display unit including a touch panel capable of receiving a user input; and
a control unit that controls the display unit to divide a display region into a main region and a sub-region, display default information or event information on the sub-region, and display a changed area of the sub-region in response to the user input, determines whether there is a user input on the sub-region, and if the user input moves from the sub-region more than a first distance, controls the display unit to extend the sub-region and display detailed default information or detailed event information.

12. The electronic device of claim 11, wherein if the user input moves from the sub-region more than the first distance, the control unit further controls the display unit to display additional information associated with the default information or the event information displayed on the sub-region, to rearrange the default information or the event information, or to enlarge an icon or thumbnail image included in the default information or the event information.

13. The electronic device of claim 11, wherein if the user input moves more than a second distance, the control unit further executes one of a service, function or application associated with the default information or the event information, or controls the display unit to display an execution screen of the service, function or application.

14. The electronic device of claim 13, wherein the second distance is farther from the sub-region than the first distance.

15. The electronic device of claim 14, wherein the control unit further controls the display unit to display the execution screen such that the execution screen fades-in and the detailed default information or the detailed event information fades-out.

16. The electronic device of claim 14, wherein if the user input is released after moving from the sub-region more than the first distance and less than the second distance, the control unit further controls the display unit to reduce a size of the extended sub-region to a pre-extended size.

17. The electronic device of claim 16, wherein the control unit further controls the display unit to reduce the size of the extended sub-region at a speed proportional to a moving distance of the user input.

18. The electronic device of claim 14, wherein if a new event occurs, the control unit further controls the display unit to overlay new event information on the default information or the event information displayed on the sub-region.

19. The electronic device of claim 18, wherein if the user input is released after moving from the sub-region more than the first distance and less than the second distance, the control unit further controls the display unit to display the event information instead of the new event information on the sub-region.

20. The electronic device of claim 11, wherein the sub-region includes at least one of an icon display region, a content display region, a time display region, and a function display region.
